(19) United States
(12) Patent Application Publication
(10) Pub. No.: US 2018/0158056 A1
(43) Pub. Date: Jun. 7, 2018

(54) Systems and Methods for Use in Facilitating an In-Merchant Shopping Experience

(71) Applicant: MASTERCARD INTERNATIONAL INCORPORATED, Purchase, NY (US)

(72) Inventors: Kyle Williams, O'Fallon, MO (US); David J. Senci, Troy, IL (US); Brett J. Thomson, Lake St. Louis, MO (US)

(21) Appl. No.: 15/366,372

(22) Filed: Dec. 1, 2016

(51) Int. Cl. G06Q 20/40; G06Q 20/20; G06Q 30/06

(52) U.S. Cl. CPC G06Q 20/401; G06Q 30/0633; G06Q 20/208

(57) ABSTRACT

Disclosed are exemplary embodiments of systems and methods for facilitating a shopping experience of a customer during a shopping session. In an exemplary embodiment, a method includes capturing, by a computing device, an identifier associated with a product during a shopping session involving a consumer and transmitting an item authorization for the product to an issuer of a payment account associated with the consumer. The method also includes accessing, in a product data structure, a weight associated with the product based on the identifier. The method further includes appending the weight to a total session weight at a virtual shopping cart when the item authorization is confirmed, and initiating, by the computing device, a payment transaction separate from the item authorization when a checkout request is received and the total session weight matches a physically measured total session weight comprising the product.

### FIELD

The present disclosure generally relates to systems and methods for use in enabling a consumer to scan and/or enter selected products as he/she shops, and further for enabling the consumer to check out of the shopping session quickly and easily when shopping is complete, and potentially without further scanning of the selected products.

### BACKGROUND

This section provides background information related to the present disclosure which is not necessarily prior art.

Products (e.g., goods, services, etc.) are known to be offered for sale, and to be sold, by merchants in stores. A consumer shopping in a store, such as a grocery store, department store, or the like, explores the various products offered, selecting one or more products that he/she would like to purchase. Once the consumer is done selecting products, he/she must “checkout” in order to complete the purchase of the products. The checkout process typically involves the consumer approaching a point of sale (POS) terminal in the store where a product (or products) to be purchased is/are scanned at the terminal (whether by a clerk and/or the consumer), followed by a payment transaction between the consumer and the terminal. After the checkout is completed, the consumer is able to exit the merchant with his/her product(s).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating a shopping experience of a consumer;

FIG. 2 is a block diagram of a computing device that may be used in the exemplary system of FIG. 1;

FIG. 3 is an exemplary method, which may be implemented in connection with the system of FIG. 1, for facilitating the consumer's shopping experience via a shopping application; and

FIGS. 4-7 are exemplary interfaces, which may be implemented in connection with the system of FIG. 1 and/or the method of FIG. 3, for enabling the consumer's shopping experience via the shopping application.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Shopping with merchants generally requires consumers to gather products to be purchased and to “checkout” in order to complete purchases of the products. In merchants, such as, for example, grocery stores, department stores, or the like, selected products are scanned and/or entered into point-of-sale (POS) terminals at the end of shopping experiences by store clerks or the consumers (e.g., the products are scanned/entered into checkout systems which are linked to the physical POS terminals, etc.). Due to the time it takes to scan the product(s), checkout in this manner often results in consumers waiting in lines to complete their transactions and leave the merchants. Uniquely, the systems and methods herein enable consumers to scan and/or enter selected products via their smartphones or other communication devices into shopping carts while they shop at the merchants. In particular, as a consumer selects or chooses products during a shopping session, he/she scans the products and places them in a physical shopping cart. A shopping application, included in the consumer's communication device, for example, receives the scanned product information and maintains a virtual “shopping cart” for the shopping session (based on the selected products placed in the physical shopping cart). In addition, the shopping application initiates an item authorization for each of the selected products (e.g., to ensure that available funds are present to purchase the product prior to adding the products to the virtual “shopping cart,” etc.). Then, when the consumer is finished shopping, he/she may checkout with his/her selected products, whereby the weight of the products in the physical shopping cart (as provided by a scale, for example) is verified and/or compared against an expected weight of the products in the virtual “shopping cart.” And, once verified, the consumer is permitted to initiate a final payment transaction for the selected products, as a group (e.g., via the shopping application, via a POS terminal, etc.), and exit the merchant (while receiving a virtual receipt for the transaction (e.g., within the shopping application, via SMS, via email, etc.)), thereby avoiding individually scanning and/or manually entering the products included in the physical shopping cart at the checkout.

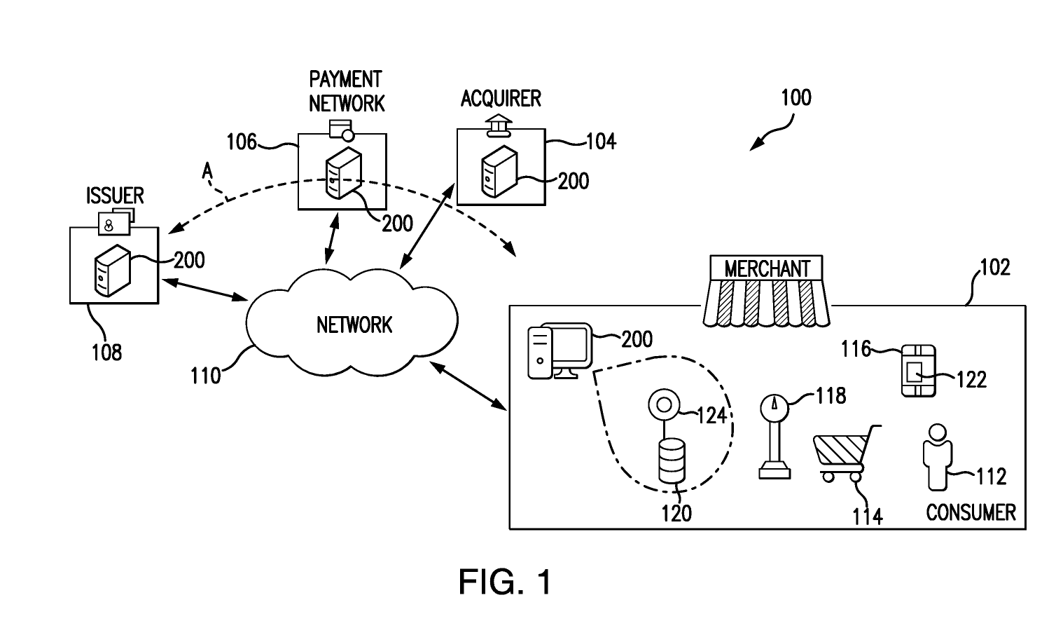

FIG. 1 illustrates an exemplary system 100, in which one or more aspects of the present disclosure may be implemented. Although, in the described embodiment, the system 100 is presented in one arrangement, other embodiments may include the system 100 arranged otherwise, depending, for example, on processing of transactions, merchant configurations, etc.

Referring to FIG. 1, the system 100 generally includes a merchant 102, an acquirer 104 associated with facilitating purchase transactions performed at the merchant 102, a payment network 106, and an issuer 108 configured to issue payment accounts to consumers, each coupled to (and in communication with) network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the payment network 106 to the acquirer 104 and the issuer 108 and, separately, a public network (e.g., the Internet, etc.) through which the merchant 102 and the acquirer 104 may communicate (e.g., via a website or via various network-based applications, etc.).

In the system 100, the merchant 102 offers products (e.g., goods and/or services, etc.) for sale to consumers, such as consumer 112. The merchant 102 may further provide shopping carts (e.g., physical shopping cart 114, etc.), each of which may include a unique cart identifier, for use by consumers (e.g., consumer 112, etc.) at locations of the merchant 102. A shopping cart identifier on the shopping cart 114 may be placed such that it is viewable by the consumer 112 (e.g., on or near the handle of the shopping cart 114, etc.) and/or scannable by the consumer 112 (or by a communication device 116 associated with the consumer 112), etc. The shopping cart identifier may be in the form of numbers, letters, symbols, computer-readable indicia, or the like. Further, as shown in FIG. 1, the merchant 102 includes a scale 118 which is configured to permit consumers (e.g., the consumer 112, etc.) to weigh the shopping carts (e.g., cart 114, etc.) before and/or after the consumers place product(s) into the shopping carts while shopping. The scale 118 may be located near the entrance of the merchant 102, or elsewhere, and is generally sized such that at least one shopping cart can be positioned thereon. The scale 118 may be configured to measure the weight of the shopping cart positioned upon it and/or identify the shopping cart identifier associated with said shopping cart.

The consumer 112 is associated with a payment account issued to the consumer 112 by the issuer. In addition, as shown, the consumer 112 is also associated with the communication device 116. The communication device 116 may include, for example, a smartphone, a tablet, or another computing device, as described herein, but is generally a portable and/or handheld device suitable to be carried with the consumer 112. In at least one embodiment, however, the communication device 116 is associated with the merchant 102 (e.g., a portable product scanner, etc.) and/or is coupled to the shopping cart 114 for use by the consumer 112 during one or more shopping sessions. In any case, use of the communication device 116 (whether associated with the consumer 112 or the merchant 102) is described in more detail below.

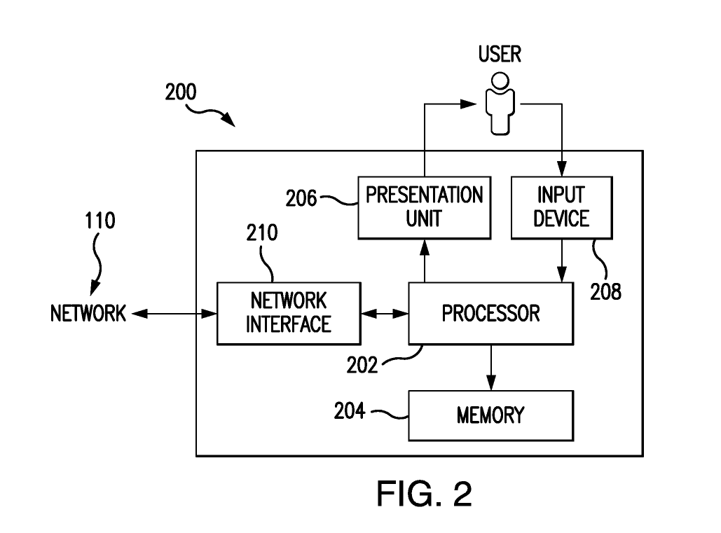

FIG. 2 illustrates an exemplary computing device 200 that can be used in the system 100 of FIG. 1. The computing device 200 may include, for example, one or more servers, workstations, routers, personal computers, tablets, laptops, smartphones, PDAs, etc. In addition, the computing device 200 may include a single computing device, or it may include multiple computing devices located in close proximity or distributed over a geographic region, so long as the computing devices are specifically configured to function as described herein.

In the exemplary system 100 of FIG. 1, each of the merchant 102, the acquirer 104, the payment network 106, and the issuer 108 are illustrated as including, or being implemented in, computing device 200, coupled to (and in communication with) the network 110. In addition, the portable communication device 116 associated with consumer 112 (or when associated with the merchant 102) can also be considered a computing device generally consistent with computing device 200 for purposes of the description herein. However, the system 100 should not be considered to be limited to the computing device 200, as described below, as different computing devices and/or arrangements of computing devices may be used. In addition, different components and/or arrangements of components may be used in other computing devices.

The exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, payment account parameters (e.g., payment tokens, etc.), shopping cart data, product data, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information, either visually or audibly to a user of the computing device 200, such as, for example, the consumer 112 at the communication device 116, etc. It should be further appreciated that various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an LED, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, a scan of a product identifier and/or a product confirmation input, etc. The input device 208 is coupled to (and is in communication with) the processor 202 and may include, for example, a keyboard, a pointing device, a mouse, a button, a stylus, a touch sensitive panel (e.g., a touch pad or a touch screen, etc.), a camera or other optical input device or scanner, a radio frequency identification (RFID) device, another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth™ adapter, a RFID adapter, etc.), a mobile network adapter, or other device capable of communicating to/with one or more different networks, including the network 110. In one example, the network interface 210 includes a RFID adapter/interface, etc. Further, in some exemplary embodiments, the computing device 200 includes the processor 202 and one or more network interfaces 210 incorporated into or with the processor 202.

Referring again to FIG. 1, as shown, the merchant 102 includes a product data structure 120. The product data structure 120 includes data and/or parameters relating to products carried at the merchant 102, including, for instance, product identifiers, product names, product prices, product weights, product descriptions, product nutritional information, product warning information, product categories, related discounts and/or coupons, etc. The product data structure 120 is stored in memory, such as, for example, memory 204 (e.g., in the computing device 200 of merchant 102, etc.). It should be appreciated that while the product data structure 120 is illustrated as included in the merchant 102, in other embodiments the product data structure 120 may be remote from the merchant 102 and/or associated with multiple different merchants (and/or merchant locations for a common merchant having multiple such locations), etc.

Also in the system 100, the communication device 116 includes a shopping application 122 and the merchant 102 includes a shopping engine 124 (e.g., associated with the computing device 200 as indicated by the dotted lines in FIG. 1, etc.), which together cooperate to facilitate the operations described herein. With that said, when the communication device 116 is described as configured to perform various operations herein, it should be appreciated that it may be doing so generally in coordination with the shopping application 122 (even if the application 122 is not specifically referenced), or not.

In general in the system 100, the shopping application 122 is installed and/or provided in the communication device 116 to configure, by executable instructions, the communication device 116 to enable the consumer 112 to scan products into a virtual shopping cart during a shopping session (e.g., as the products are placed into a physical shopping cart, etc.) and to facilitate purchase of the products at the end of the shopping session (e.g., without further individually scanning or checking the products at a POS terminal at checkout as in traditional shopping sessions, etc.). Specifically, the shopping application 122 is configured to cause the communication device 116 (often in response to inputs from the consumer 112) to initially scan, read, and/or collect a cart identifier from a shopping cart, then to scan, read, and/or collect product identifiers of selected products during a shopping session, and then to compile a virtual shopping cart of the scanned products, etc.

In connection therewith, the shopping application 122 and/or the shopping engine 124 are/is configured to generate/compile (e.g., individually, in connection with a POS terminal at the merchant 102, etc.) item authorizations for each of the products, individually, as they are selected by the consumer 112 (e.g., as the product identifiers for each of the selected products are scanned, read, and/or collected during the shopping session, etc.). By compiling the item authorizations for each of the products as it is selected by the consumer 112, the shopping application 122 and/or the shopping engine 124 provide(s) a unique record for each product, for example, in the virtual shopping cart for the consumer 112. In so doing, the unique record makes subsequently identifying different ones of the selected products more convenient (e.g., for billing purposes, for return purposes, etc.) and allows the issuer 108 and/or the consumer 112 to confirm that sufficient funds are available at the consumer's payment account, for example, to actually purchase each subsequently selected product, prior to appending the product to a virtual shopping cart for the consumer 112 (and prior to actual checkout at the merchant 102). As an example, in using the individual item authorizations where the consumer 112 purchases ten of the same product, when the consumer 112 ultimately checks out at the merchant 102, his/her receipt will identify the purchase of the ten same products. Then, if the consumer 112 later decides to return one of the ten products, he/she simply returns one of the item authorizations associated with the products, whereby the merchant 102, for example, may then do a reversal on the returned item authorization and/or do a return with a clearing record on the returned item authorization. As such, for dual message transactions, the individual item authorization records can be appended appropriately to the various messages, and for single message transactions, a reversal can be requested on the compiled list of item authorizations.

In one example, when the consumer 112 selects a product at the merchant 102 and scans the product with his/her communication device 116 (via input device 208, for example), the shopping application 122 at the communication device 116 is configured to facilitate an item authorization for the scanned product. In connection therewith, the shopping application 122 may be or may include or may be in communication with a payment application (e.g., MasterPass®, Apple Pay®, Samsung Pay®, PayPal®, Google Wallet®, Android Wallet™, etc.) associated with the consumer 112. As such, in facilitating the item authorization, the shopping application 122 compiles (from the product data structure 120 and from the payment application) various data relating to the product and the potential purchase of the product by the consumer 112 including, for example, a product description for the product, a product price, applicable tax, payment account credentials for the consumer's payment account, etc.

Then, in connection with generating the item authorization for the selected product, the merchant 102 receives, via communication with the communication device 116 (e.g., via NFC, Bluetooth™, wireless network communication, etc.), an indication of the selected product (and the various data related thereto) and a token associated with the consumer's payment account (as provided by the payment application). In turn, the merchant 102 (e.g., a POS terminal at the merchant 102, the shopping engine 124, etc.) compiles an ISO 8583 authorization message for the selected product and includes an indicator in a data element of the message identifying the request as an item authorization (as opposed to a purchase authorization request, etc.). The merchant 102 then transmits the authorization message (broadly, the item authorization) to the acquirer 104, along path A in the system 100, as referenced in FIG. 1, and the acquirer 104 communicates the authorization message with the issuer 108, through the payment network 106, such as, for example, through MasterCard®, VISA®, Discover®, American Express®, etc., to determine whether the consumer's payment account is in good standing and whether there are sufficient funds and/or credit in the consumer's payment account to cover the identified product. In response, the issuer 108 transmits a reply back to the merchant 102, along path A, and the merchant 102 provides the reply to the consumer 112 at the communication device 116, thereby permitting the consumer 112 to make a determination of whether to maintain the selected product in his/her shopping cart 114 or remove it. This is done for each product selected by the consumer 112 during the shopping session (and desired to be included in the consumer's virtual shopping cart).

Further in the system 100, when all desired products are selected and placed in the shopping cart 114 (e.g., at the end of the shopping session, etc.) and when item authorizations for all desired products in the consumer's virtual shopping cart are confirmed, the shopping application 122 and/or the shopping engine 124 are/is configured to communicate with (or cause the communication device 116 and/or the merchant's computing device 200 to communicate with) the scale 118 to determine an actual weight of the shopping cart with the selected products therein (as measured by the scale 118). The shopping application 122 and/or the shopping engine 124 are/is configured to then access weights for the corresponding products in the consumer's virtual shopping cart from the product data structure 120 (either at the end of the shopping session or throughout the shopping session as products are added to the virtual shopping cart), to tabulate a total weight for products included in the virtual shopping cart at the end of the shopping session, and to compare the tabulated weight to the actual weight of the products in the shopping cart 114 (as measured at the scale 118) (i.e., the total weight at the scale 118 less the tare weight of the shopping cart 114). Further, the shopping application 122 and/or the shopping engine 124 are configured to verify (or cause the communication device 116 and/or the merchant's computing device 200 to verify) the products in the shopping cart 114, when the compared weights are within a defined threshold or deviation of one another.

Once the weight of the selected products in the shopping cart 114 is verified, in this exemplary embodiment, the shopping application 122 and/or the shopping engine 124 are configured to initiate (or cause the communication device 116 and/or the computing device 200 to initiate) a final purchase transaction for the products in the virtual shopping cart (and in the physical possession of the consumer 112). Such purchase transaction is performed separate from (and subsequent to) the multiple individual item authorization interactions discussed above. For example, in performing the purchase transaction, the shopping application 122 and the shopping engine 124 (and/or the scale 118) may cooperate to provide a POS terminal for the merchant 102, whereby the consumer 112 is able to view the details of the purchase transaction (e.g., a listing of products included in the consumer's virtual shopping cart (e.g., a listing of products that have been authorized, etc.), an amount per product, sales tax, a total purchase amount, etc.), at the communication device 116 or at another presentation unit 206 at the merchant 102, and/or to enter and/or select a payment account for use in funding the transaction.

In one example purchase transaction, the consumer 112 (at the end of the shopping session) may initiate the transaction with the merchant 102 via the shopping application 122 on the consumer's communication device 116. In turn, the merchant 102 receives, via communication with the communication device 116 (e.g., via NFC, Bluetooth™ wireless network communication, etc.), the token associated with the consumer's payment account (or another payment account) and then communicates a purchase authorization request (e.g., including the payment account token and an amount of the purchase, etc.) to the acquirer 104 (e.g., in the form of an ISO 8583 message as described above in connection with the item authorizations but without the item authorization indicator, etc.). The purchase authorization request is transmitted along path A in the system 100, as referenced in FIG. 1 (and as generally described above in connection with the item authorizations). The acquirer 104 communicates the purchase authorization request with the issuer 108, through the payment network 106, to determine whether the consumer's payment account is in good standing and whether there are sufficient funds and/or credit to cover the transaction. In turn, if approved, a purchase authorization reply (indicating the approval of the transaction) is transmitted back from the issuer 108 to the merchant 102, along path A, thereby permitting the merchant 102 to complete the transaction. The purchase transaction is later cleared and/or settled by and between the merchant 102, the acquirer 104, and the issuer 108. If declined, however, the purchase authorization reply (indicating a decline of the transaction) is provided back to the merchant 102, along the path A, thereby permitting the merchant 102 to halt or terminate the transaction.

Transaction data is generated, collected, and stored as part of the above interactions among the merchant 102, the payment network 106, the acquirer 104, and the issuer 108. The transaction data represents at least a plurality of interactions, for example, authorized transactions, cleared transactions, attempted transactions, etc. The transaction data, in this exemplary embodiment, is stored at least by the payment network 106 (e.g., in a data structure (described below) associated therewith, etc.). Additionally, or alternatively, the acquirer 104 and/or the issuer 108 may store the transaction data, or part thereof, in a data structure, or transaction data may be transmitted between parts of system 100, as used or needed (e.g., for settlement and/or clearing, etc.). With that said, transaction data may include, for example, primary account numbers (PANs), amounts of the transactions, merchant IDs, merchant category codes (MCCs), dates/times of the transactions, products purchased and related descriptions or identifiers, etc. It should be appreciated that more or less information related to transactions, as part of either authorization, clearing, and/or settling, may be included in transaction data and stored within the system 100, at the merchant 102, the acquirer 104, the payment network 106, and/or the issuer 108.

In various exemplary embodiments, consumers (e.g., consumer 112, etc.) involved in the different transactions and/or interactions herein are prompted to agree to legal terms associated with their payment accounts and/or network-based applications (e.g., shopping application 122, etc.), for example, during enrollment in their accounts and/or installation of such applications, etc. In so doing, the consumers may voluntarily agree, for example, to allow merchants, issuers, payment networks, etc., to use data collected and/or generated during enrollment, or later, and/or in connection with processing purchase transactions to the payment accounts, subsequently, for subsequent use in general and for one or more of the different purposes described herein.

Additionally or alternatively, in some embodiments, the shopping application 122 may configure the communication device 116 to permit the consumer 112 to search for products to determine availability and/or location of products at merchant 102. Further, the shopping application 122 may configure the communication device 116 to permit the consumer 112 to create and save a shopping list of products prior to beginning a shopping session, such that, as products on the shopping list are scanned and/or selected during a shopping session, the products are removed, struck out, or otherwise marked, enabling the consumer to keep track of progress with respect to the saved shopping list. The shopping application 122 may further configure the communication device 116 to respond to errors during a shopping session (e.g., if a measured weight of the cart's contents does not match a calculated weight of the cart's contents during a checkout attempt, the shopping application 122 may provide prompts to aid the consumer in solving the error, etc.). It should be understood that, in some embodiments, the shopping application 122 may be configured for more, less, or different functionality, without departing from the description herein.

In addition, the shopping engine 124 may configure the computing device 200 to collect shopping cart weight data as it is measured by the scale 118, and store the collected weight data in a data structure (not shown) for use in determining a weight of the products in the physical shopping cart 114. Empty shopping cart weight data may be collected at the beginning of a shopping session, or at some other time unrelated to the shopping session (and then associated with the cart identifier for the shopping cart 114), to determine the weight of the shopping cart 114 (without products therein).

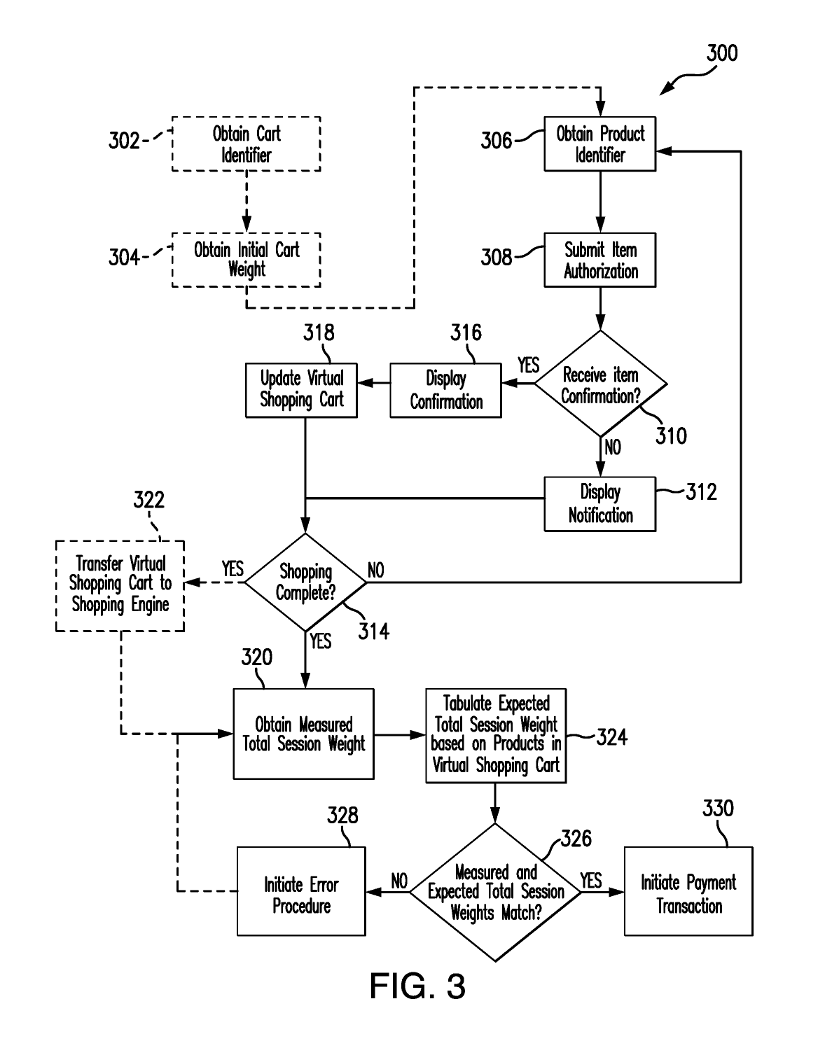

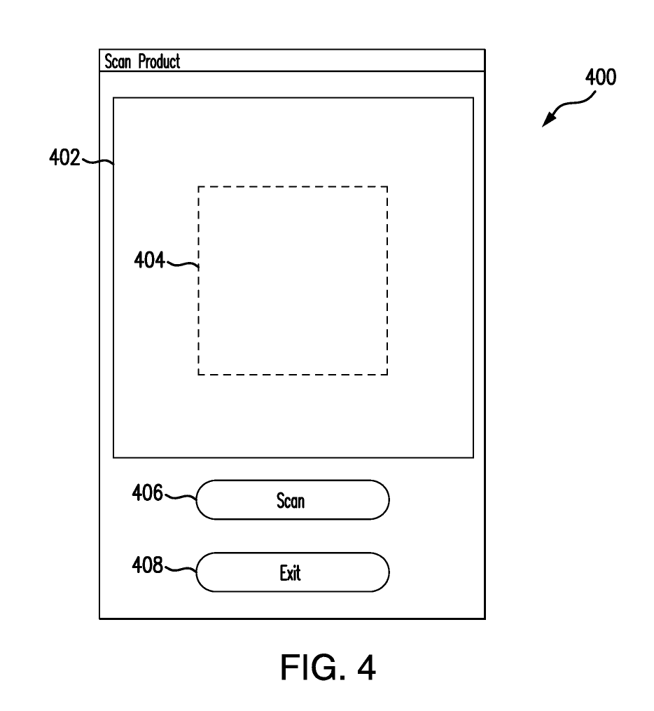

FIG. 3 illustrates exemplary method 300 for facilitating a shopping experience for a consumer using a shopping application. In the exemplary embodiment, the method 300 is described with reference to the consumer 112, the communication device 116, the shopping application 122, the merchant 102, the issuer 108, the payment network 106, and further with reference to the computing device 200. It should be appreciated, however, that the methods herein are not limited to system 100 and the computing device 200, and the systems and computing devices are not limited to method 300. Further, the description of method 300 refers to exemplary interfaces 400-700, shown in FIGS. 4-7, respectively. The method 300, however, should not be understood to be limited to the exemplary interfaces 400-700, as other interfaces, or no interfaces may be employed in methods described herein.

At 302, the consumer 112 may select a cart 114 from a designated cart area within or nearby the merchant 102. In connection therewith, the consumer 112 may use the shopping application 122 on the communication device 116 to obtain the unique cart identifier. The shopping application 122 may initiate a new shopping session and associate the obtained cart identifier with the new shopping session. In some embodiments, the shopping application 122 may send a message to the shopping engine 124 that causes the shopping engine 124 to create the new shopping session associated with the cart identifier. It should be understood that 302 is illustrated with dotted lines because, in some embodiments, a cart identifier is not used, such that obtaining the cart identifier is omitted.

At 304, the consumer 112 may be instructed, by the shopping application 122, to weigh the cart 114 in order to obtain an initial cart weight. The shopping application 122 may provide instructions on how to use the scale 118 of the merchant 102 to obtain the initial cart weight. When the consumer 112 positions the cart 114 on the scale 118 and the weight is captured by the scale 118, the shopping engine 124 may collect the initial cart weight from the scale 118. Then, the shopping engine 124 may provide the initial cart weight to the shopping application 122 (or not). Further, the scale 118 may obtain a cart identifier of the cart 114 while weighing the cart 114, enabling the shopping engine 124 and/or shopping application 122 to confirm that the cart 114 linked to the shopping session is being used. It should be understood that 304 is also illustrated with dotted lines because, in some embodiments, the weight of the cart 114, or a reference weight of the available shopping carts, may already be stored by the shopping engine 124 (and associated with the corresponding card identifiers) and the weighing of the cart at the beginning of the shopping session may be omitted.

During the shopping session, at 306, the consumer 112 selects a product and uses the communication device 116 and shopping application 122 to obtain a product identifier associated with the product. Obtaining the product identifier may include scanning, reading, or otherwise detecting computer-readable indicia on or in the product. For instance, consumer 112 may use a camera input device on communication device 116 in conjunction with the shopping application 122 to scan a universal product code (UPC), quick response (QR) code, or other similar computer-readable indicia printed or otherwise marked on the product. Alternatively or additionally, the shopping application 122 may be used to detect a product identifier via RFID, Bluetooth™, NFC, or the like. Further, the product identifier may be obtained by enabling the consumer 112 to enter the identifier manually into the shopping application 122. For instance, the consumer 112 may enter a serial number or other similar identifying code into the shopping application 122 to select the product. Alternatively or additionally, the consumer 112 may enter the name of the product or other potential identifying terms into the shopping application 122, such that the shopping application 122 causes a search of the product data structure 120 to be executed for the entered terms. The shopping application 122 may then provide search results to the consumer 112, from which the consumer 112 may select the appropriate product.

FIG. 4 illustrates an exemplary product scanning interface 400 that may be used with (or displayed through) the shopping application 122. The scanning interface 400 includes a photo section 402, an overlay 404, a scan button 406, and a cancel/exit button 408. Interface 400 may be displayed on a screen or similar interface of the communication device 116, enabling the consumer 112 to scan computer-readable indicia on a product. The photo section 402 may display a view of the captured input of a camera or similar device of the communication device 116 (e.g., for capturing a product identifier, etc.). The overlay 404 indicates a portion of the photo section 402 with which to position the computer-readable indicia of the product when scanning the product to obtain the product identifier. For instance, if the product to be scanned includes a QR code, the consumer 112 may hold the product and communication device 116 in such a way that the QR code of the product is displayed on the photo section 402 within, or substantially within, the overlay 404. In alternative embodiments, an overlay may not be present, as the entirety of the photo section 402 may be used for scanning.

Then in the interface 400, when the computer-readable indicia are lined up with the overlay 404 of the photo section 402, the consumer 112 may activate the scan button 406. The scan button 406, when activated, may cause the communication device 116 to photograph, record, scan, read, or otherwise detect the computer-readable indicia. A scanning process may include analyzing photographed or recorded optical input of the computer-readable indicia to transform the optical input into another form of data, such as a product identifier in the form of a serial number or the like.

However, if the consumer 112 decides against scanning a product, he/she may activate the cancel button 408. When activated, the cancel button 408 may cause the product scanning interface 400 to disappear and be replaced by or change into a different interface of the shopping application 122 or of a different application.

In some embodiments, scanning a product is followed by the shopping application 122 obtaining product data/parameters, including product weight, based on the product identifier, and displaying them to the consumer 112. Other product parameters may include product names, product prices, product descriptions, product nutritional information, product warning information, product categories, recommended/related products, related discounts and/or coupons, etc.

The shopping application 122 may obtain the product weight and/or other data/parameters from the product data structure 120 associated with merchant 102, or from a local data structure of the shopping application 122 and/or a scanned product itself. For instance, the shopping application 122 may send a request to the shopping engine 124 of merchant 102 to obtain the product parameters. The request may include the obtained product identifier, as well as other data, such as a consumer identifier, communication device identifier, or the like. The shopping engine 124 may provide a response to the request including product parameters that are stored in the product data structure 120. Alternatively or additionally, when the shopping application 122 is installed on the communication device 116, the installation may include a product data structure similar to and/or the same as the product data structure 120 of the merchant 102. Then, the shopping application 122 may merely access the local product data structure to obtain the product weight and/or other product parameters. Further, the product parameters may be obtained from the product itself, either during the process of obtaining the product identifier or afterward. For instance, the shopping application 122 may scan computer-readable indicia on the product that include the product parameters as well as the product identifier. An embedded RFID chip in the product may include the product parameters. Alternatively or additionally, the consumer 112 may be enabled to manually provide the product parameters (e.g., the consumer 112 may be prompted to enter the weight listed on the product into the shopping application 122, etc.).

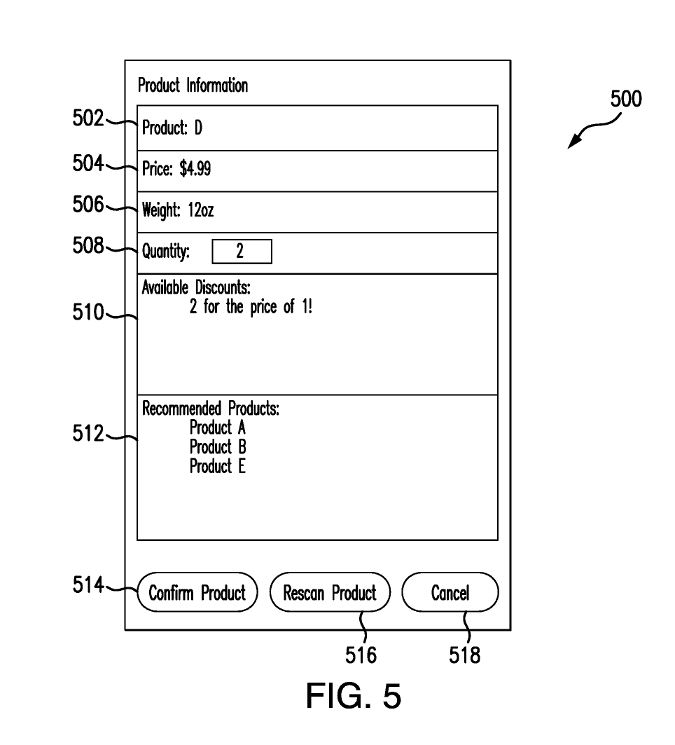

Once the product weight and/or other parameters are obtained, they may be displayed (or not) to the consumer 112 by the shopping application 122. FIG. 5 illustrates an exemplary interface 500 that may be used in connection with the shopping application 122 to show a product and the associated product parameters. In connection therewith, the illustrated interface 500 includes various product parameter sections, particularly a product name section 502, a product price section 504, a product weight section 506, a product quantity section 508, an available discounts section 510, and a recommended products section 512.

The product name section 502, product price section 504, and product weight section 506 display the respective parameters of product “D” to the consumer 112 (in the illustrated interface 500). The quantity section 508 enables the consumer 112 to report that he/she is selecting more than one of the displayed product. If the consumer 112 wants several of the same product, he/she can fill out the quantity selected, rather than scanning each product separately. As shown in FIG. 5, the consumer 112 is selecting two of the displayed products “D”. The available discounts section 510 may display discounts, coupons, deals or the like that apply to the scanned product. For instance, as shown, the scanned product is on sale for “2 for the price of 1”. Other discounts may include percentages or amounts off of the price, lowered prices based on purchasing a combination of related items, etc.

The recommended products section 512 of the interface 500 may display zero or multiple other products that may be related to the scanned product. For instance, if consumer 112 scans a jar of pasta sauce at a grocery store, the recommended products section 512 may display pasta products to go with the pasta sauce. Recommended products may be determined based on predefined product relationships, managing product relationships based on whether products are often purchased together, etc. The interface 500 further includes a confirm product button 514, a rescan product button 516, and a cancel button 518. The confirm product button 514, when activated, causes the scanned product to be selected for inclusion in the consumer's shopping cart 114, as will be described below. Further, when the consumer 112 activates the rescan product button 516, the shopping application 122 may return to a scanning interface (e.g., scanning interface 400, etc.), enabling the consumer 112 to rescan the product in the event that the product parameters shown are not accurate. If the consumer 112 decides not to select the product, activating the cancel button 518 will cause the product parameter interface 500 to disappear and be replaced by or change into a different interface of the shopping application 122 or of a different application.

It should be appreciated that more, different, or other content may be included in other interfaces at the communication device 116. For example, when scanned and/or selected, the interfaces may omit parameters relevant to the transaction and/or the verification herein, but not generally informative to the consumer 112 (e.g., the weight of the product, etc.).

Referring again to FIG. 3, at 308, the shopping application 122 next submits (broadly, facilitates) an item authorization for the selected product (e.g., upon selection of the confirm product button 514 in the interface 500, etc.). As described above in the system 100, in so doing, the shopping application 122 initially compiles various data relating to the product and the potential purchase of the product by the consumer 112 (as obtained at 306), for example, a product description for the product, a product price, applicable tax, etc. from the product data structure 120. In addition, the shopping application 122 compiles data relating to the consumer's payment account to be used in the potential transaction (e.g., payment account credentials for the payment account, etc.), for example, from the payment application at the consumer's communication device 116, directly from the consumer 112, etc. Then, the shopping application 122 transmits the item authorization (e.g., a request for item authorization, etc.) to the merchant 102 (e.g., via NFC, Bluetooth™, wireless network communication, etc.), and the merchant 102 communicates the item authorization to the acquirer 104 (e.g., the merchant 102 compiles an ISO 8583 authorization message/request and includes an indicator in a data element of the message identifying it as a request for item authorization, etc.). In turn, the acquirer 104 communicates the item authorization with the issuer 108, through the payment network 106, to determine whether the consumer's payment account is in good standing and whether there are sufficient funds and/or credit in the consumer's payment account to cover the identified product. The issuer 108, upon recognizing the communication as an item authorization (as opposed to a purchase authorization request), via the item authorization indicator in the ISO 8583 authorization message, transmits a reply (either with a confirmation or not) back to the consumer 112 at the communication device 116 (via the merchant 102), thereby permitting the consumer 112 to make a determination of whether to maintain the selected product in his/her shopping cart 114 or remove it.

At 310, when the item authorization for the selected product is not confirmed by the issuer 108 (e.g., when insufficient funds are present in the consumer's payment account to purchase the selected product, etc.), for example, a notification is displayed to the consumer 112, at 312, regarding the insufficient funds (e.g., at an interface at the consumer's computing device 116, etc.). And, in this example, the shopping application 122 then does not add/append the selected product to the consumer's virtual shopping cart. In response, the consumer 112 may remove the selected product from the shopping cart 114, or the consumer 112 may opt to keep the selected product and pay for it in another manner when checking out, for example, using a different payment account, using cash, etc. The consumer 112 may then continue shopping for additional products at the merchant 102, or not, at 314 (as described in more detail hereinafter).

Conversely at 310, when the item authorization for the selected product is confirmed by the issuer 108 (e.g., when sufficient funds are present in the consumer's payment account to purchase the selected product, etc.), for example, a confirmation is displayed to the consumer, at 316, indicating that purchase of the selected product through the consumer's payment account is available (e.g., at an interface at the consumer's computing device 116, etc.). In turn, at 318, the shopping application 122 updates the consumer's virtual shopping cart to include the selected item. For example, the shopping application 122 may cause the selected product, including its product identifier, to be recorded or appended to the virtual shopping cart with other selected products for the current shopping session. The virtual shopping cart may be stored and/or maintained by the shopping application 122 on the communication device 116, and/or it may be maintained at the shopping engine 124 of the merchant 102. Appending the selected product to the virtual shopping cart may cause an associated expected total session weight value to be increased by the product weight of the selected product. Product weight provides a measurement by which the shopping application 122 and/or the shopping engine 124 may confirm the accuracy of the contents of the virtual cart in comparison to the measured total session weight at the end of a shopping session. Other values may also be altered as a result of appending the selected product. For instance, a total session price value may be increased by the product price of the selected product, a total product count may be increased by one (or by another number if more than one of the product was selected), a total applied discount value may be increased if the selected product includes an associated discount, etc. It should be understood that, in some embodiments, the virtual shopping cart may be stored and/or maintained on the communication device 116 by the shopping application 122, and the selected products in the virtual shopping cart may be either retained by the shopping application 122 until the end of the shopping session or communicated to the shopping engine 124 throughout the shopping session. If the selected products are communicated to the shopping engine 124 throughout the shopping session, the communication may occur at regular intervals, irregular intervals, whenever a product is appended to the virtual shopping cart, or like times. Alternatively, if the virtual shopping cart is stored and/or maintained by the shopping engine 124, the selected products may be communicated to the shopping engine 124 from the shopping application 122 upon the shopping application 122 obtaining the product identifier as described above.

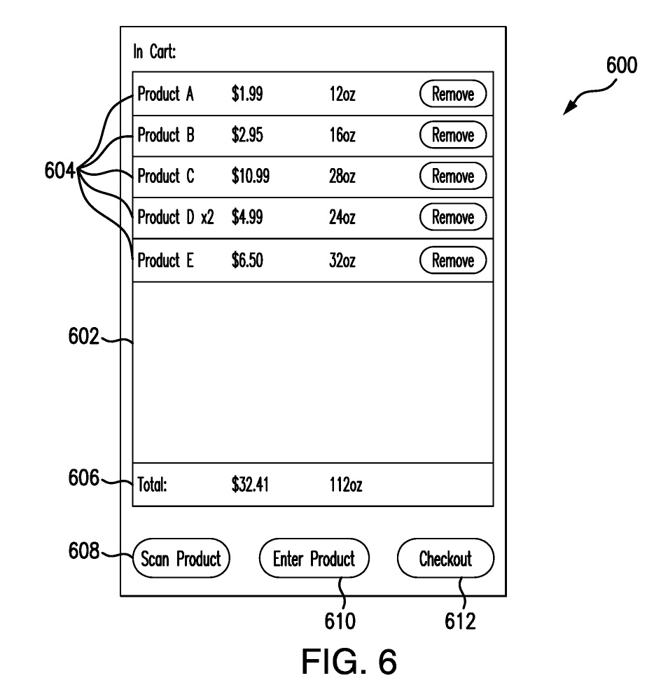

After the virtual shopping cart is updated with the selected product, the current set of selected products in the virtual cart may be displayed to the consumer 112 by the shopping application 122. FIG. 6 illustrates an exemplary product list interface 600 that may be used in connection with the shopping application 122 for displaying a set of selected products and associated data and/or parameters. Product list interface 600 includes a list section 602, product sections 604, a total section 606, a scan product button 608, an enter product button 610, and a checkout button 612. The list section 602 is a region where product sections 604 may be displayed on a screen or similar interface of the communication device 116. Each product section 604 includes information, data, and/or parameters of a product that has been selected by the consumer 112 for inclusion in the shopping cart 114. For instance, as shown, the list section 602 includes five product sections 604. Each product section 604 includes a product name, a product price, and a product weight (or more or less information). Further, each product section 604 includes a remove button which, when activated, causes the associated product section 604 to be removed from the list section 602. Additionally, the associated product, product identifier, and product parameters are removed from the virtual shopping cart associated with the current shopping session. The total section 606 includes a running total sum of prices and weights of the selected products.

The scan product button 608, when activated, may cause the shopping application 122 to change the interface to a scanning interface (e.g., scanning interface 400, etc.). The enter product button 610, when activated, may enable the consumer 112 to input a product identifier and/or other product parameters in order to add a product to the list manually. For instance, activating of the enter product button 610 may cause an interface to be displayed that enables the consumer 112 to enter a serial number of a product, view the parameters of the entered product in an interface (e.g., product parameter interface 500, etc.), and confirm the product for inclusion in the virtual shopping cart of the current shopping session. The checkout button 612, when activated, causes the shopping application 122 to initiate a checkout process, ending the current shopping session.

Referring yet again to FIG. 3, at 314, the shopping application 122 determines whether the shopping session is complete. This may involve receiving, or not, an input from the consumer 112 indicating that the shopping session is complete, for example. If the consumer 112 is not finished, he/she may continue to scan or otherwise select new products, returning to 306. However, if the consumer 112 indicates that the shopping session is complete (e.g., the consumer 112 may activate the checkout button 612 of interface 600 in FIG. 6, etc.), the shopping application 122 may continue on to the checkout process, at 320. In some embodiments when the shopping session is complete, at 322, the virtual shopping cart may (optionally, as indicated by the broken lines) be sent, transferred, or otherwise communicated to the shopping engine 124 from the shopping application 122.

Regardless, when checking out, at 320, the shopping application 122 obtains a final measured cart weight value. In order to obtain the final measured cart weight value, the consumer 112 may be required to position the cart 114 on the scale 118 of the merchant 102. The scale 118 may then weigh the cart 114 and the products therein to determine the final measured cart weight. The shopping engine 124, which is in communication with the scale 118, may collect the final measured cart weight from the scale 118 and provide it to the shopping application 122. A measured total session weight may be calculated by the shopping engine 124 and/or the shopping application 122 by subtracting the initial cart weight from the final measured cart weight.

At 324, the expected total session weight may be tabulated based on products in the virtual shopping cart. In some embodiments, the virtual shopping cart may include an expected session weight value that is updated throughout the shopping session as products are appended to the virtual shopping cart, such that the expected total session weight of the virtual shopping cart is the expected session weight value of the virtual shopping cart after the shopping session is completed at 314. Alternatively, the shopping application 122 and/or the shopping engine 124 may add the weights of each of the products in the virtual shopping cart only at the end of the shopping session, at 324. The shopping application 122 and/or the shopping engine 124 may access the weights of the products from the product data structure 120 based on the associated product identifiers.

At 326, the measured total session weight is compared to the expected total session weight. The two weight values are considered to match when the difference between the values is within a defined threshold. The defined threshold may be a defined value difference (e.g., the two values must differ by less than 2 lbs. to match, etc.), a relative, or percentage difference (e.g., the two values must differ by less than 5%, etc.), product specific thresholds (i.e., each product may include an allowable weight variance parameter which may be combined with all the other products to determine an allowable weight variance for all of the selected products for the session), etc. Further, defined thresholds for products may differ based on the price of the products. For example, a defined threshold for a television or other consumer electronic product having a generally higher price may be smaller (i.e., the threshold requires a more precise weight match to be satisfied) than a defined threshold for a bag of rice, or other less expensive product. If the two values fail to match, an error procedure may be initiated, at 328. Otherwise, a payment transaction may be initiated for the selected products, at 330 (in a similar manner to the example transaction described above with reference to FIG. 1).

In alternative embodiments, the comparison of the measured total session weight and the stored total session weight (at 326) may be done by the shopping engine 124 of the merchant 102. In that case, the result of the comparison may be provided to the shopping application 122 in order to notify the consumer 112 and/or advance the checkout process.

At 328, the shopping application 122 initiates an error procedure due to the stored total session weight being inaccurate with respect to the measured total session weight. The error procedure may include providing instructions for confirming accurate scanning of all products in the cart 114, suggestions for products that may have been scanned an inaccurate number of times based on the difference between the stored and measured weights, instructions for how to contact customer service of the merchant 102, and/or instructions to proceed to a conventional checkout lane to continue the checkout process, etc. If the consumer 112 is able to remedy the error in the list of selected products in the virtual shopping cart, he/she may request to retry the checkout procedure, returning to 320. Alternatively, if the consumer 112 is unable to remedy the error, it may be necessary for the consumer 112 to be directed to contacting customer service and/or proceeding to a conventional checkout aisle to continue checking out.

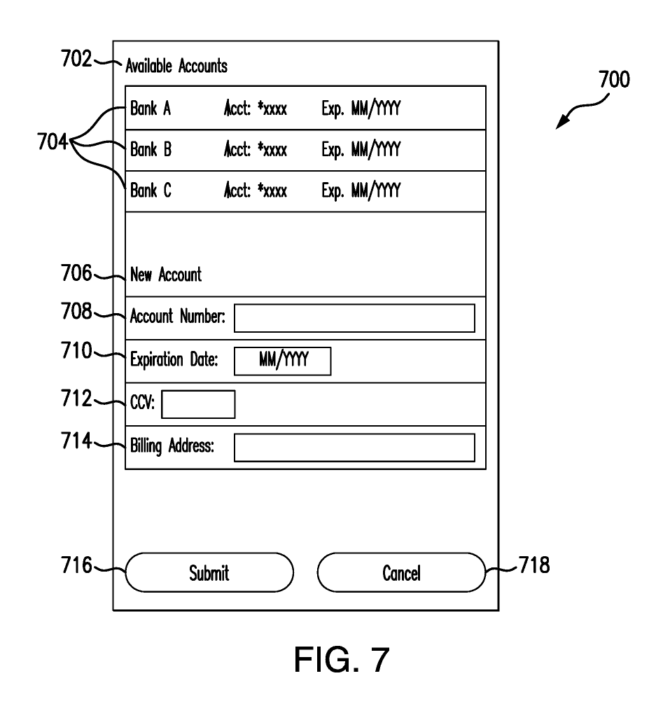

Conversely, at 330, when the stored product list is considered accurate based on the weight comparison at 324 described above and the shopping application 122 enables the consumer 112 to initiate a payment transaction for the selected products. The shopping application 122 may have stored previously entered payment account information for the consumer 112. Alternatively or additionally, the shopping application 122 may solicit payment account information from the consumer 112. For instance, FIG. 7 illustrates an exemplary payment interface 700 that may be used in connection with the shopping application 122 for use in making a payment during the checkout process. The payment interface 700 includes an available accounts section 702 with account rows 704, and a new account section 706 with an account number row 708, an expiration date row 710, a card verification value (CVV) row 712, and a billing address row 714. The payment interface also includes a submit button 716 and a cancel button 718. The available accounts section 702 may display account rows 704 for payment accounts for which the consumer 112 may have already entered information (e.g., already entered to the payment application 122, retrieved from a payment application at the communication device, etc.). To facilitate a fast checkout process, consumer 112 may select one of the account rows 704 as the source of payment rather than enter payment account information. Alternatively, the consumer 112 may fill payment account information into the new account section 706, including an account number into the account number row 708, an expiration date into the expiration date row 710, a CVV into the CVV row 712, and a billing address into the billing address row 714.

When an available account has been selected or new account information has been entered, the consumer 112 may activate the submit button 716, which may cause the shopping application 122 to initiate a payment transaction using the selected account or the account associated with the entered new account information. The payment transaction may follow path A of FIG. 1, as described above. Alternatively, the consumer 112 may activate the cancel button 718, which may cause the shopping application 122 to cancel the checkout process and return to a different interface (e.g., product list interface 600, etc.).

Once the checkout process is complete, the shopping session is ended with respect to the shopping application 122. A receipt may be provided to the consumer 112 that indicates the shopping session has been successfully completed. In some embodiments, the receipt may be a virtual receipt that may be accessed and/or displayed on the communication device 116. Alternatively or additionally, a receipt may be printed out or otherwise provided to the consumer 112 by the merchant 102 at or in proximity to the scale 118. An employee of the merchant 102 may review the receipt after the consumer 112 completes the shopping session as an additional accuracy check in some embodiments. The consumer 112 may return the cart 114 to a designated cart area and leave the merchant 102 location with his/her purchased products.

In view of the above, through use of the shopping application 122, for example, a consumer shopping in merchant locations may avoid lengthy checkout processes by scanning, or otherwise capturing, his/her selected products in a virtual shopping cart as he/she adds the products to a physical shopping cart during a shopping session. In addition, item authorizations are generated for each of the products selected by the consumer, for example, to help ensure that sufficient funds are present in the consumer's payment account to cover the accumulation of products. Then, once the consumer selects his/her desired products, he/she may complete the shopping session by simply weighing the shopping cart on a scale to confirm that the weight of the selected products matches an expected product weight. Thus, the shopping session is streamlined by simplifying the checkout process as described herein.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) capturing a cart identifier and an initial cart weight associated with a shopping cart for use during a shopping session by a consumer; (b) capturing an identifier associated with a product during the shopping session; (c) transmitting an item authorization for the product to an issuer of a payment account associated with the consumer; (d) accessing, in a product data structure, a weight associated with the product based on the identifier, when the item authorization is confirmed; (e) appending the weight to a total session weight associated with a virtual shopping cart including the product; (f) accessing a price and/or product name and/or weight associated with the product based on the identifier; (g) appending the identifier and the price and/or product name and/or product weight to the virtual shopping cart associated with the shopping session, again when the item authorization is confirmed; (h) soliciting at least one payment account parameter associated with a payment account of the consumer; (i) confirming the cart identifier when a checkout request is received; (j) capturing a final cart weight when the checkout request is received; and (k) initiating a payment transaction, separate from the item authorization, when the checkout request is received and the total session weight matches a physically measured total session weight comprising the product, whereby the shopping session is concluded via a checkout process.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating a shopping experience of a consumer during a shopping session, the method comprising:
capturing, by a computing device, an identifier associated with a product during a shopping session involving a consumer;
transmitting an item authorization for the product to an issuer of a payment account associated with the consumer;
accessing, in a product data structure, a weight associated with the product based on the identifier;
appending the weight to a total session weight associated with a virtual shopping cart including the product when the item authorization is confirmed; and
initiating, by the computing device, a payment transaction separate from the item authorization, when a checkout request is received and the total session weight matches a physically measured total session weight comprising the product, whereby the shopping session is concluded via a checkout process.

2. The method of claim 1, wherein accessing, in the product data structure, the weight associated with the product includes accessing, by the computing device, in the product data structure, the weight associated with the product.

3. The method of claim 1, wherein accessing, in the product data structure, the weight associated with the product includes accessing, by a shopping engine separate from the computing device, in the product data structure, the weight associated with the product.

4. The method of claim 1, further comprising:
accessing, by the computing device, a price and/or product name associated with the product based on the identifier;
appending, by the computing device, the identifier and price and/or product name to the virtual shopping cart associated with the shopping session; and
wherein the payment transaction is based on a sum of prices appended to the data structure associated with the shopping session.

5. The method of claim 1, wherein accessing, in a product data structure, a weight associated with the product based on the identifier includes at least one of accessing a product data structure of the computing device and accessing a product data structure external to the computing device via a network interface.

6. The method of claim 1, further comprising soliciting at least one payment account parameter associated with a payment account of the consumer;
wherein, the payment account is a basis for confirming the item authorization and is a source of payment for the payment transaction; and
wherein the at least one payment account parameter includes at least one of a primary account number (PAN), a token associated with a PAN, an account number, an expiration date, a CVV, and a billing address.

7. The method of claim 1, further comprising causing to be displayed, by the computing device, at least one of an instruction to confirm accurate capture of product identifiers, a suggestion of a product identifier that may have been inaccurately captured, a confirmation of an item authorization, and an instruction for contacting customer service when a checkout request is received and the total session weight does not match the measured total session weight.

8. The method of claim 1, further comprising:
capturing, by the computing device, a cart identifier and an initial cart weight associated with a shopping cart for use during the shopping session; and
confirming the cart identifier when a checkout request is received.

9. The method of claim 8, further comprising capturing a final cart weight when a checkout request is received; and
wherein the measured total session weight is based on a difference between the initial cart weight and the final cart weight.

10. A system for facilitating a shopping experience of a consumer during a shopping session, the system comprising:
a processor communicatively coupled to a scale;
a memory coupled to the processor, the memory including a product data structure including weights for multiple products at a merchant, the memory also including processor-executable instructions that, when executed by the processor, cause the processor to:
receive a product identifier for a product selected by a consumer during a shopping session and compile an item authorization for the product, the item authorization including at least a price for the product and a payment account parameter associated with a payment account of the consumer;
when the item authorization for the product is confirmed, access a weight associated with the product from the product data structure;
append the weight to a total session weight for the shopping session at a virtual shopping cart associated with the consumer;
receive a final cart weight of a shopping cart holding the product, as determined at the scale; and
provide a confirmation when the total session weight matches a difference between an initial cart weight and the final cart weight, whereby products in the shopping cart are substantially verified to be consistent with products included in the virtual cart.

11. The system of claim 10, wherein the processor-executable instructions define a shopping engine.

12. The system of claim 11, further comprising a communication device including a processor and memory, the memory including processor-executable instructions that, when executed by the processor of the communication device, cause the communication device to:
capture the product identifier associated with the product;
cause the product identifier to be included in the virtual shopping cart when the item authorization for the product is confirmed; and
initiate a payment transaction when a checkout request is received and the total session weight and the difference between the initial cart weight and the final cart weight are confirmed to match.

13. The system of claim 12, wherein the processor-executable instructions included in the memory of the communication device, when executed by the processor of the communication device in connection with capturing the product identifier, cause the communication device to at least one of optically capture computer-readable indicia of the product identifier, detect the product identifier via radio frequency identification (RFID) communication, and receive manual input of the product identifier.

14. The system of claim 13, wherein the processor-executable instructions included in the memory of the communication device, when executed by the processor of the communication device in connection with capturing the product identifier, cause the communication device to optically capture computer-readable indicia of the product identifier; and
wherein the computer-readable indicia of the product identifier include at least one of a universal product code (UPC) and a quick response (QR) code.

15. The system of claim 12, wherein the processor-executable instructions included in the memory of the communication device, when executed by the processor of the communication device, further cause the communication device to solicit the at least one payment account parameter associated with the payment account of the consumer;
wherein, the payment account is a basis for confirming the item authorization and is a source of payment for the payment transaction; and
wherein the at least one payment account parameter includes at least one of a primary account number (PAN), a token associated with a PAN, an account number, an expiration date, a CVV, and a billing address.

16. The system of claim 12, wherein the processor-executable instructions included in the memory of the communication device, when executed by the processor of the communication device, further cause the communication device to display at least one instruction to confirm accurate capture of the product identifier, suggestion of a product identifier that may have been inaccurately captured, a confirmation of an item authorization, and instruction for contacting customer service when a checkout request is received and the total session weight does not match the difference between the initial cart weight and the final cart weight.

17. The system of claim 10, wherein the processor-executable instructions, when executed by the processor, further cause the processor to record the initial cart weight of the shopping cart as measured by the scale.

18. A non-transitory computer readable storage media including instructions for facilitating a shopping experience of a consumer during a shopping session that, when executed by a processor, cause the processor to:
compile an item authorization for each of multiple products as the products are selected by a consumer during a shopping session;
for each of the multiple products, append said product to a virtual shopping cart associated with the consumer when the item authorization for said product is confirmed by an issuer of a payment account associated with the consumer;
receive a weight associated with a physical shopping cart containing at least the product(s) appended to the virtual shopping cart in connection with the shopping session by the consumer;
tabulate weight for the virtual shopping cart associated with the consumer during the shopping session, each of the multiple products included in the virtual shopping cart having a product weight;
compare the received weight of the shopping cart to the tabulated weight of the virtual shopping cart for the shopping session;
initiate a payment transaction for the multiple products included in the virtual shopping cart; and
cause a receipt to be transmitted to a communication device associated with the consumer.

19. The non-transitory computer readable storage media of claim 18, further including instructions that, when executed by the processor, cause the processor to cause an error to be generated when a result of the comparison of the received weight to the tabulated weight is not within a defined threshold.

20. The non-transitory computer readable storage media of claim 18, further including instructions that, when executed by the processor, cause the processor to retrieve the product weight for each of the multiple products included in the virtual shopping cart from a product data structure.
